(19) United States
(12) Patent Application Publication
(10) Pub. No.: US 2021/0262635 A1
(43) Pub. Date: Aug. 26, 2021

(54) Angle Adjustable Lamp

(71) Applicant: Xiamen Longstar Lighting Co., Ltd, Xiamen (CN)

(72) Inventor: Xilong Li, Xiamen (CN)

(73) Assignee: Xiamen Longstar Lighting Co., Ltd

(21) Appl. No.: 16/984,883

(22) Filed: Aug. 4, 2020

(30) Foreign Application Priority Data
Feb. 25, 2020 (CN) 202020206221.5

(51) Int. Cl. F21V 1/14; F21V 1/16

(52) U.S. Cl. CPC F21V 1/143; F21W 2121/00; F21V 1/16

(57) ABSTRACT

The invention provides an angle adjustable lamp, which comprises a lamp body, radiators, connecting rods and fight-transmissive covers. The radiators are rotationally connected with a side wall of the lamp body through the connecting rods, and the radiators are rotationally symmetrically distributed around a longitudinal central axis of the lamp body. The light-transmissive cover is installed at one side of the radiator away from the lamp body, and when the radiator rotates around the connecting rod, the angle between the light-transmissive cover and the lamp body changes accordingly, and the light-emitting angle of light transmitted through the light-transmissive cover also changes accordingly. For the above-mentioned adjustable lamp, a focus lighting position can be adjusted by users as required.

### FIELD OF THE INVENTION

The current disclosure relates to the field of light emitting devices, in particular to an angle adjustable lamp.

### BACKGROUND OF THE INVENTION

Existing light emitting lamps, such as CN103527963, comprise a lamp holder and a drive circuit board, wherein the drive circuit board is attached on the lamp holder; the drive circuit board comprises six rectangular panels and a round panel; the six rectangular panels encloses a cylinder; one end of the cylinder is fixed on the lamp holder; the round panel is fixed on the other end of the cylinder; LED light sources are uniformly distributed on the rectangular panels and the round panel; and the LED light sources are installed to form a corn shape, so that a problem of limited light emitting angle of a single LED light source is solved, and the LED light sources can emit light to 360 degrees to make the light distribution is more uniform. However, the LED light sources emit light uniformly and have no focus lighting. It cannot be adjusted to satisfy positions requiring more illumination, and the light emission is limited.

### SUMMARY OF THE INVENTION

The utility model provides an adjustable lamp, which can be adjusted by users to satisfy positions which focus lighting is needed.

The technical solution adopted by the application to solve the technical problem is as follows:

an angle-adjustable lamp comprising a lamp body, radiators, connecting rods and light-transmissive covers;

wherein the radiators are rotationally connected with a side wall of the lamp body through the connecting rods, and the radiators are rotationally symmetrically distributed around a longitudinal central axis of the lamp body;

the light-transmissive cover is installed at one side of the radiator away from the lamp body, and when the radiator rotates around the connecting rod, the angle between the light-transmissive cover and the lamp body changes accordingly, and a light-emitting angle of light transmitted through the light-transmissive cover also changes accordingly.

In one embodiment, two lugs protrudes from a side surface of the lamp body respectively at positions corresponding to each radiator, and one side of the radiator facing the lamp body is provided with a connector; the lugs and the connector are respectively provided with through holes; the connecting rod is connected with an end cap after passing through the through holes of the lug and the connector.

In one embodiment, a surface of the radiator is provided with grid-shaped radiating holes.

Compared with the prior art, the technical solution has the following advantages:

The application provides an angle adjustable lamp, which can be adjusted by rotating a radiator to change the angle between a light emitting cover and a lamp body so as to give more light to places needing more illumination at another angle. For example, in exhibition halls, at some places, more illumination needs to be given to murals on walls, and at some other places, more illumination only needs to be given to passages of visitors, which can be achieved by adjusting the angle of the lamp.

### BRIEF DESCRIPTION OF THE DRAWINGS

FIG. 1 shows a top view of an angle adjustable lamp according to an embodiment;

FIG. 2 is a front view of an angle adjustable lamp according to an embodiment;

Reference numeral: End cap—1, Connecting Rod—2, Radiator—3, Lamp Body—4, Lamp base—5, Screw—6, Light-transmissive cover—7.

### DETAILED DESCRIPTION OF THE INVENTION

The application will be further explained below with reference to the drawings and the specific embodiments.

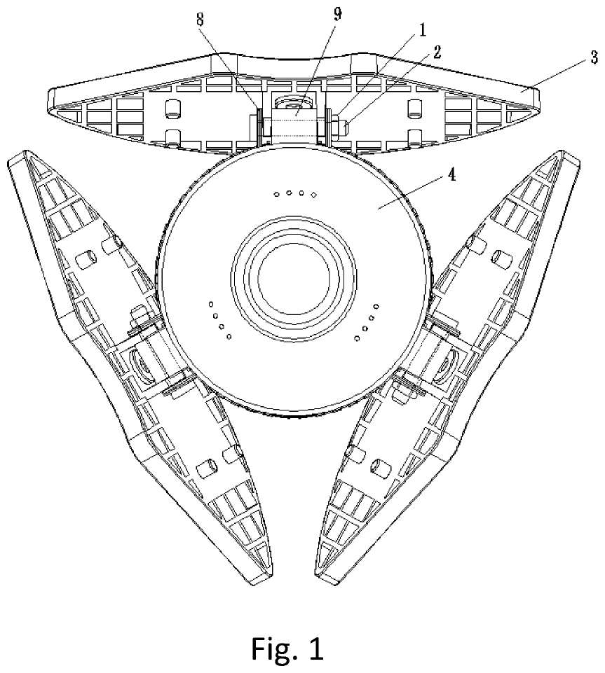

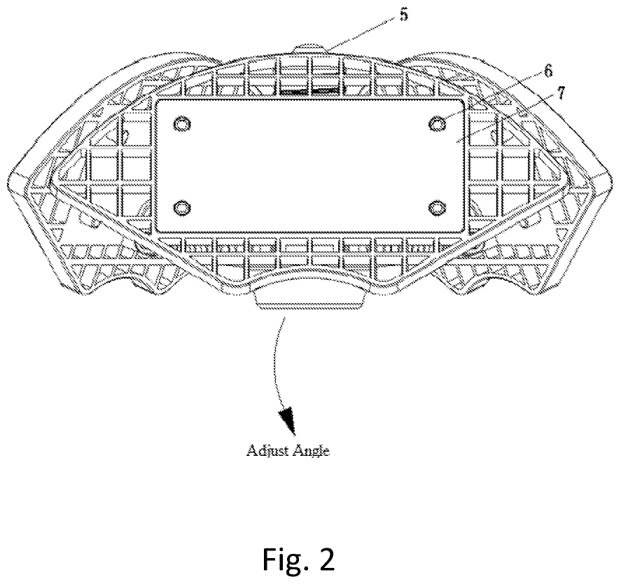

Please refer to FIG. 1 and FIG. 2. An angle adjustable lamp comprises end caps 1, connecting rods 2, radiators 3, a lamp body 4, a lamp head 5, screws 6, light-transmissive covers 7, lugs 8 and connectors 9.

The radiators 3 are rotationally connected with a side wail of the lamp body 4 through the connecting rods 2, and the radiators 3 are rotationally symmetrically distributed around a longitudinal central axis of the lamp body 4.

The light-transmissive cover 7 is installed on a side of the radiator 3 away from the lamp body 4. When the radiator 3 rotates around the connecting rod 2, an angle between the light-transmissive cover 7 and the lamp body 4 changes accordingly, and the light-emitting angle of the light transmitted through the light-transmissive cover 7 also changes accordingly. The above-mentioned angle-adjustable lamp can be adjusted by rotating the radiator to change the angle between the light-emitting cover and the lamp body so as to give more light to places requiring more illumination at another angle. For example, in an exhibition hall, at some places, more illumination needs to be given to murals on walls, and at some other places, more illumination only needs to be given to passages of visitors, which can be achieved by adjusting the angle of the lamp. In this way, the adjustment of the focus lighting region can be achieved under the premise of 360 degrees of light emission.

In order to implement the rotary connection between the lamp body 4 and the radiator 3, two lugs 8 protrude from a side surface of the lamp body 4 at positions corresponding to each radiator 3 respectively, and the radiator 3 facing one side of the lamp body is provided with a connector 9. The lugs 8 and the connector 9 are provided with through holes respectively. The connecting rod 2 is connected with the end cap 1 after passing through the through hole of the lug 8 and the connector 9.

Finally, in this embodiment, the surface of the heat radiator 3 is provided with grid-shaped heat dissipation holes.

The above is only a preferred embodiment of this application, so the implementation scope of this application cannot be limited in this way, i.e. based on the embodiments in this application, all other embodiments obtained by those of ordinary skill in the art without creative effort are within the scope of protection in this application.

1. An angle adjustable lamp comprising a lamp body, radiators, connecting rods a light-transmissive covers;
wherein the radiators are rotationally connected with a side wall of the lamp body through the connecting rods, and the radiators are rotationally symmetrically distributed around a longitudinal central axis of the lamp body, the radiators having the shape of an annulus sector;
the light-transmissive cover is installed at one side of the radiator away from the lamp body, and when the radiator rotates around the connecting rod, the angle between the light-transmissive cover and the lamp body changes accordingly, and the light-emitting angle of light transmitted through the light-transmissive cover also changes accordingly.

2. The angle adjustable lamp of claim 1 wherein the lamp body has two lugs protrude from a side surface of the lamp body respectively at positions corresponding to each radiator, and one side of the radiator facing the lamp body is provided with a connector; the lugs and the connector are respectively provided with through holes; the connecting rod is connected with end cap after passing through the through holes of the lug and the connector.

3. The angle adjustable lamp of claim 1 wherein the surface of the radiator is provided with grid-shaped radiating holes.
